(19) United States
(12) Patent Application Publication
(10) Pub. No.: US 2013/0331472 A1
(43) Pub. Date: Dec. 12, 2013

(54) DEVICE FOR BROADHEAD AND SHARP OBJRCTS

(71) Applicant: James Steven Marshek, Ames, IA (US)

(72) Inventor: James Steven Marshek, Ames, IA (US)

(73) Assignee: James Steven Marshek, Ames, IA (US)

(21) Appl. No.: 13/494,829

(22) Filed: Jun. 12, 2012

(51) Int. Cl. C08F 110/02

(52) U.S. Cl. 521/143

(57) ABSTRACT

The Broadhead Block is comprised of a closed cell, cross linked, polyethylene foam. The block is cut in the form of a cube that can be held in one's hand while being used. It has multiple sides to allow a number of objects to be secured into each side as desired. The closed cell construction of the polyethylene allows for continued penetrations with a long lasting durability. Thus providing means to loosen or tighten broad heads on the shaft of the arrow, while acting as a protective shield from the sharp blades. It acts as a wrench allowing one to grip the block instead of the sharp or broken broad heads while performing either installation or removal of said blades or broad head points from arrows.

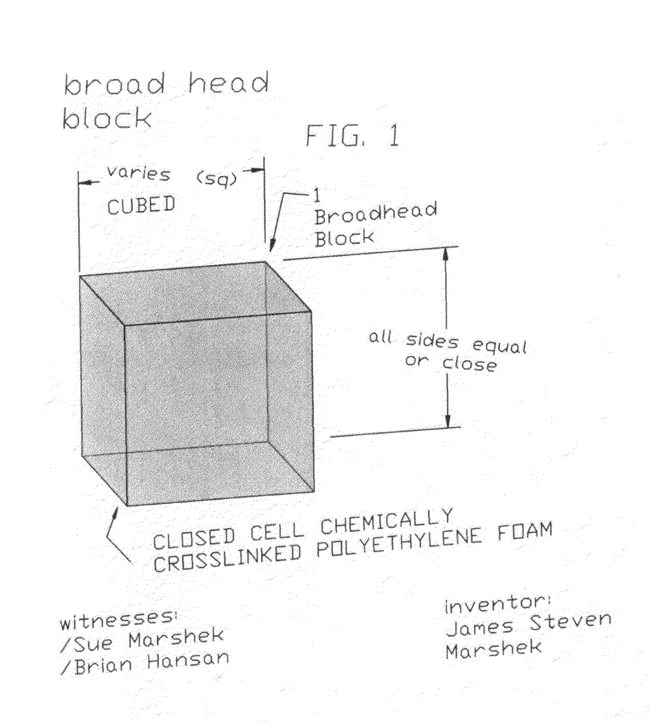

Present invention, noted in FIG. 1 as item 1, the block relates to its use as a protector and a storage devise of such objects with sharp edges or pointed ends that may need to be shielded or protected.

noted in FIG. 1 as item 1, The block is also a solid foam container allowing broad heads to be secured, changed, uninstalled, and or reinstalled during time of need.

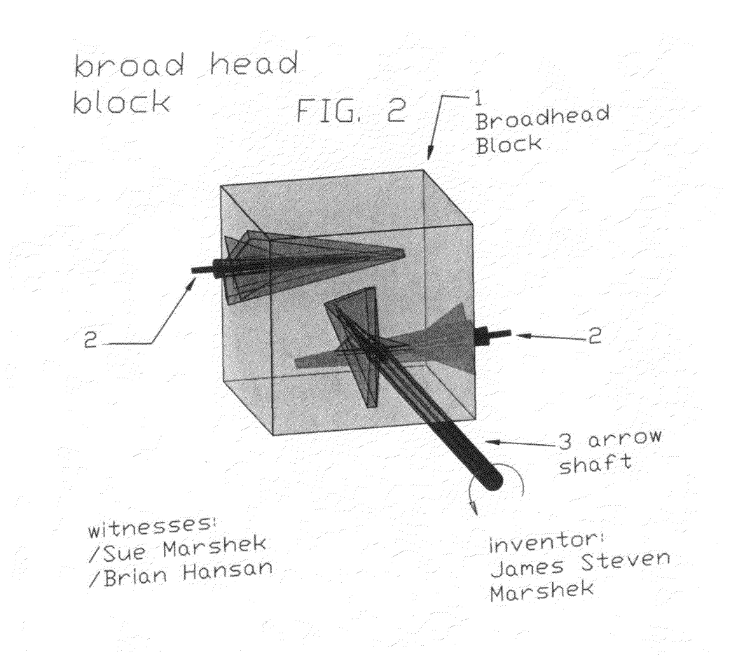

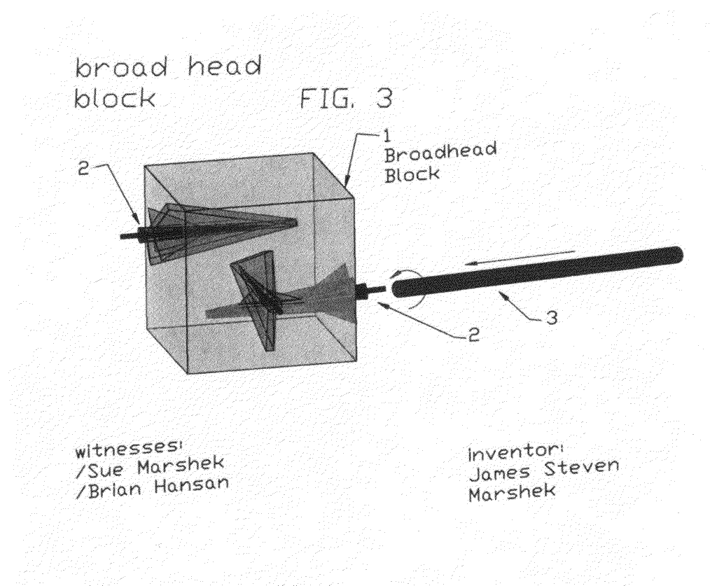

The block is cut in the shape of a cube, oval of cylindrical shape that fits readily into a hand, as shown in drawing FIG. 1 in drawing 1/3 and can be used as a wrench to tighten or loosen broad heads while secured in the block as shown on drawings also in FIG. 2 on drawing 2/3 & FIG. 3 on drawing 3/3. With a simple twisting, turning action, of either block or arrow, this exchange will take place.

The material used to construct the block is a closed cell, cross linked, polyethylene foam.

The chemical composition, is not being of claim to the Block, though inventor is claiming its nature, inherent characteristics or composition as a closed cell cross linked polyethylene foam as function to the Block's working ability, therefore it is being used as design material in the patent language. The block is made of closed cell polyethylene foam not limited to one specific formula.

### DESCRIPTION OF THE DRAWINGS

In the drawings in which similar elements are given similar reference characters:

Drawing 1/3 in FIG. 1 shows a prospective view of the general shape of item number 1 which I refer to as Broadhead Block with reference to size and shape, along with general reference to structural composition of the material used in construction of the block.

Drawing 2/3 in FIG. 2 shows a prospective view of number 1 the Broadhead Block, With item number 2 isometric representation of broad heads stalled or inserted into the Number 1 the broadhead Block, along with the isometric figure of an arrow shaft item number 3 with a broad head number 1 attached and inserted directly into the block.

Drawing 3/3 shows a prospective view of again said number 1 the Broadhead Block with the isometric representation of broad heads installed or inserted into the Block. Also represented is an isometric figure of an arrow and how it would be attached to the broad head and then removed from said block.

### SUMMARY OF THE INVENTION

The Broadhead Block overcomes the difficulties as noted above with respect to containing broad heads, within a secure safe form, while in a usable shape to also act as a wrench. There are many reasons to use the Broadhead Block while using broad heads on arrows in the field. Most often the broad heads are wedged from impact onto the ground, or other obstructions, and are extremely hard to loosen while griping the sharp, broken blades between the user's figures.

The Broadhead Block protects the person dealing with the challenges of changing out damaged, broken, or different broad heads onto the arrow shaft. Simply by inserting the broad head into the block and griping the arrow tightly and turning the block, one can remove any broad head without the worry of cutting oneself. The worries about the potential of sharp objects coming in contact with the user are virtually eliminated. Caution should always be stressed while using the block for instant removal or replacement of broad heads.

The Broadhead Block is a necessity and safety device for everyone.

1-3. (canceled)

4. An arrow broadhead holding device, comprising:
foam block having multiple sides free from pre-formed slots into which a broadhead is adapted to be forcibly inserted;
the loam block being formed of closed cell polyethylene; and
the block being sized and shaped for gripping in a person's hand.

5. (canceled)

6. The broadhead device of claim 4 wherein the block is a cube shape.

7. The broadhead device of claim 4 wherein the polyethylene is cross-linked.

8. (canceled)

9. The broadhead device of claim 5 wherein the bloc with a broadhead therein can be rotated by the person to attach or detach the broadhead from an arrow shaft.

10. A method of safely handling at broadhead arrow tip, comprising:
holding the block in a user's hand, then forcing the tip into a first side of a closed cell foam block; and then
manually rotating the block to attach and detach the tip to and from a threaded arrow shaft.

11. The method of claim 10 further comprising pulling the tip from the block after the tip is attached to the arrow shaft.

12. The method of claim 10 wherein the tip is pushed into a side of the block which is free from any pre-formed slot.

13. (canceled)

14. The method of claim 10 further comprising storing the tip in the block.

15. The method of claim 10 further comprising forcing a second broadhead arrow tip into a second side of the block.

16. A method of storing a pointed object comprising:
holding a foam body having multiple sides in one hand of a user;
holding a pointed object in the other hand of a user;
selecting one of the multiple sides of the foam body; and then
imbedding the point of the object into the selected side to store the pointed object in the body; and then
imbedding a point of a second object in a second side of the body for storage.

17. The method of claim 16 wherein the pointed objected is threadably mounted on a support member, and the method further comprising threadably uncoupling the object from the support member h holding the support member and rotating the foam body with the point imbedded therein.

18. The method of claim 16 further comprising rotating the body in a first direction to attach the pointed object onto a threaded support member and rotating the body in an opposite second direction to detach the pointed object from the support member.

19. (canceled)

20. The method of claim 16 wherein the body is a cross-linked polyethylene material.
